(19) United States
(12) Patent Application Publication
(10) Pub. No.: US 2021/0291030 A1
(43) Pub. Date: Sep. 23, 2021

(54) FENCING TRAINING DEVICES AND METHODS OF USE

(71) Applicant: Angelica Anousis, Quincy, MA (US)

(72) Inventor: Angelica Anousis, Quincy, MA (US)

(21) Appl. No.: 16/826,774

(22) Filed: Mar. 23, 2020

(51) Int. Cl. A63B 69/02; F41B 13/02; A63B 71/06

(52) U.S. Cl. CPC A63B 69/02; F41B 13/02; A63B 2209/10; A63B 2071/0694; A63B 71/0605

(57) ABSTRACT

A fencing training device including a bib, at least a portion of which comprises a material configured to provide an observable change in response to an external stimulus. Also provided is a fencing weapon that includes a handle and a blade with a tip that comprises a transferable material disposed thereon and a method of training a fencer.

### FIELD OF THE INVENTION

The invention generally relates to sports training devices and methods, and more particularly to training devices and methods for fencing.

### BACKGROUND OF THE INVENTION

In the sport of fencing, touches or “hits” are typically scored via an electronic scoring system each time one fencer contacts the other fencer's body with a fencing weapon during a fencing match. The points are tallied, and the fencer with most points wins the match. Depending on the form of fencing and type of fencing weapon, permissible targets may include an opponent's entire body or only portions thereof. In all cases, the opponent's torso is a permissible target and is generally the largest and most easily accessible target area.

Novice fencers often do not realize where they are being hit by an opponent and/or the frequency with which hits are occurring in a particular target area. The fencer may be unknowingly leaving portions of the body vulnerable to attack. Fencers may also be unable to reliably determine where their fencing weapon is touching the opponent's body and their level of accuracy. Electronic scoring systems register the hit via an electronic signal and lights and/or sounds, but these systems typically do not provide any information regarding the location of the hits.

Thus, there is a need for improved fencing training devices and methods for helping beginning fencers to improve their form and technique.

### SUMMARY OF THE INVENTION

In accordance with an aspect of the present disclosure, a fencing training device is provided, which includes a bib, at least a portion of which comprises a material configured to provide an observable change in response to an external stimulus.

In accordance with another aspect of the present disclosure, a fencing weapon is provided that includes a handle and a blade with a tip, in which the tip of the fencing weapon comprises a transferable material disposed thereon.

In accordance with a further aspect of the present disclosure, a method of training a fencer is provided, the method including: coupling a fencing training device including a wearable bib to the fencer, in which one or more portions of the bib include a material configured to provide an observable change in response to touch; displaying one or more observable changes on at least one portion of the bib in response to one or more touches, in which the observable change corresponds to each touch; and restoring the at least one portion of the bib to an original state.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a front, plan view of a fencing training device in accordance with the present disclosure;

FIG. 2 is a front, plan view of another fencing training device in accordance with the present disclosure;

FIG. 3 is a back, plan view of a further fencing training device in accordance with the present disclosure;

FIG. 4 is a perspective view of a fencing weapon in accordance with the present disclosure;

FIG. 5 is a perspective view of a fencer wearing a fencing training device in accordance with the present disclosure;

FIG. 6 is a front, plan view of a fencing training device in accordance with the present disclosure after use;

FIG. 7 is a cross-sectional view taken along line 7-7 in FIG. 6; and

FIG. 8 is a flow diagram illustrating an exemplary method of training a fencer in accordance with the present disclosure.

### DETAILED DESCRIPTION OF THE INVENTION

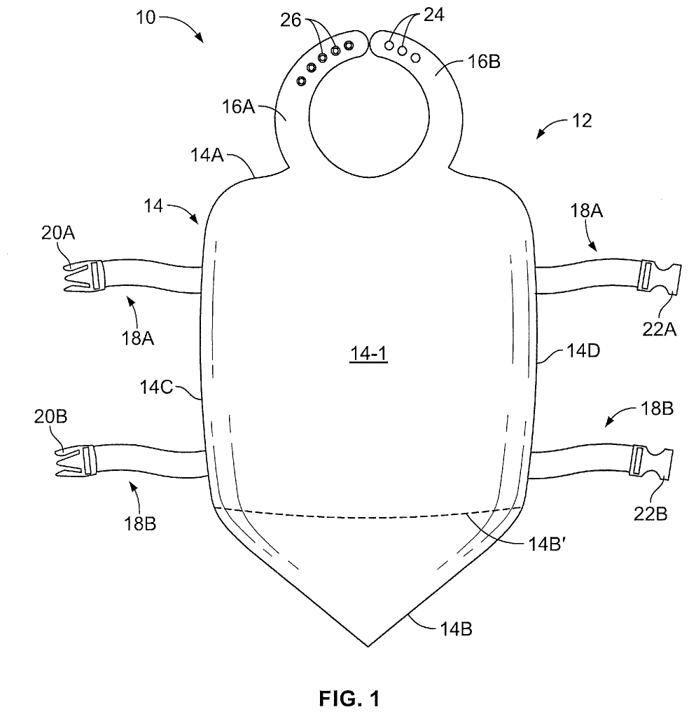

With reference to FIG. 1, a fencing training device 10 in accordance with the present disclosure is depicted. The fencing training device 10 may comprise a bib 12 with a main body 14 and a front face 14-1. The bib 12 may comprise ties 16A and 16B that may be coupled to and extend outward from an upper edge 14A of the main body 14. In some examples, the main body 14 may comprise a bottom edge 14B that is triangular, as described herein in more detail. In other examples, the main body 14 may comprise a bottom edge 14B′ that is substantially linear or slightly rounded, as shown with dashed lines in FIG. 1. The bib 12 may comprise one or more belts 18A and 18B that may be coupled to and extend outward from side edges 14C and 14D of the main body 14. Although two belts 18A and 18B are shown in FIG. 1, it is understood that the bib 12 may comprise one belt or three or more belts (not shown).

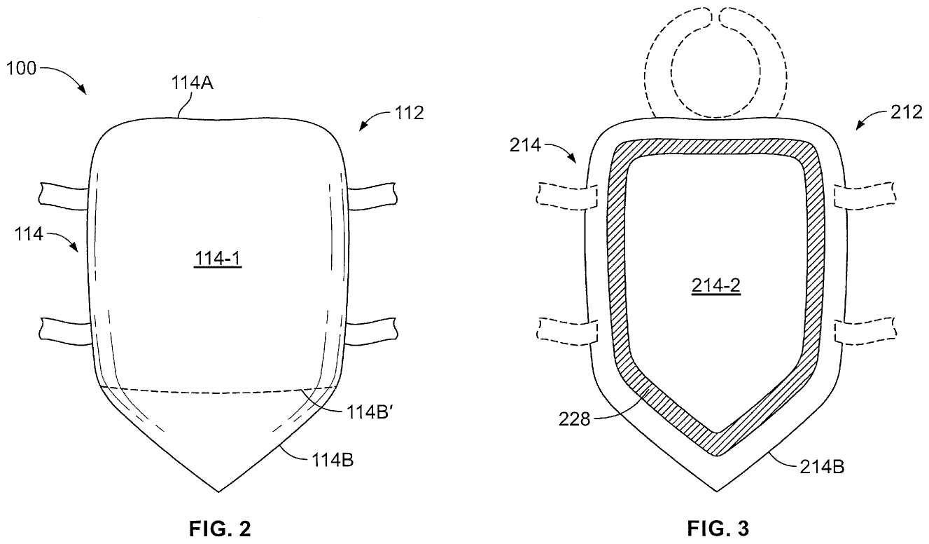

FIG. 2 is another example of a fencing training device 100 comprising a bib 112 with a main body 114 and a front face 114-1. Similar to the bib 12 shown in FIG. 1, the bib 112 may comprise one or more belts (not labeled) and a triangular bottom edge 114B or a substantially linear or slightly rounded bottom edge 114B′ (shown with dashed lines in FIG. 2). An upper edge 114A of the main body 114 may be substantially linear or slightly rounded and may lack the ties shown in FIG. 1.

The bib 12, 112 shown in FIGS. 1 and 2 may comprise any suitable material or combination of materials, including one or more natural and/or synthetic materials. The material(s) may include, for example, cotton, linen, paper, or other cellulose-based materials; polymeric materials; or a combination thereof. The bib 12, 112 may comprise a textile or fabric (woven or nonwoven), a foam such as Styrofoam or other polystyrene foam, a rubber, a polymer film or sheet, a paper sheet, or a combination thereof. As described herein in more detail, the bib 12, 112 may comprise one layer of material or a plurality of layers of material, in which the plurality of layers may comprise the same or different material as compared to each other. In some examples, the ties 16A and 16B and/or the belt(s) 18A and 18B may comprise the same material(s) as the bib 12, 112, and in other examples, the ties 16A and 16B and/or the belt(s) 18A and 18B may comprise one or more different materials. In some instances, the bib 12, 112 and the ties 16A and 16B and/or the belt(s) 18A and 18B may be formed from a single piece of material. In other instances, the ties 16A and 16B and/or the belt(s) 18A and 18B may be coupled to the bib 12, 112, e.g., via stitching, adhesive, a hook and loop fastener, and the like. The bib 12, 112, the ties 16A and 16B, and the belt(s) 18A and 18B may generally comprise a flexible material that does not restrict movement.

With reference to FIGS. 1, 2, and 5, the bib 12, 112 may be wearable and may be configured to be coupled to one or more portions of a fencer's upper body 400. In particular, the ties 16A and 16B and/or the belt(s) 18A and 18B of the bib 12 shown in FIG. 1 may be configured to couple the bib 12, 112 the fencer's upper body 400. For example, the ties 16A and 16B and/or the belts 18A and 18B may comprise one or more fasteners configured to couple the bib 12 to the fencer's upper body 400. For instance, the ties 16A and 16B may comprise one or more snap fasteners, in which one of the ties 16B comprises at least one cap 24 and the other tie 16A comprise at least one corresponding socket 26 that receives one of the caps 24. In other examples (not shown), the ties 16A and 16B may comprise regular buttons, a buckle or clasp, a hook and loop closure, and the like. In further examples (not shown), the ties 16A and 16B may comprise plain strips of material that may be tied together. The ties 16A and 16B may be fastened or tied around a neck of the fencer, as shown in FIG. 5 (only one tie 16B is visible), and may be adjustable to ensure that the bib 12 fits securely. The bib 12 may be worn over the fencer's uniform.

Each belt 18A and 18B may comprise a respective buckle or clasp. As shown in FIG. 1, the belts 18A and 18B may each comprise a side release buckle with a hook end 20A and 20B that is received in a respective receiver 22A and 22B via a snap fit. In other examples (not shown), the belt(s) 18A and 18B may comprise one or more snap fasteners, regular buttons, a hook and loop closure, and the like. In further examples (not shown), the belt(s) 18A and 18B may comprise a plain strip of material that may be tied together. The belt(s) 18A and 18B may be fastened or tied around a torso of the fencer, as shown in FIG. 5, and may be adjustable to ensure that the bib 12 fits securely.

FIG. 3 illustrates a view of a rear face 214-2 of a bib 212, which may represent either of the bibs 12 and 112 shown in FIGS. 1, 2, and 5. The bib 212 may comprise an adhesive 228 disposed on the rear face 214-2. The adhesive 228 may comprise one or more sections extending at least partially around a portion of the bib 212. The one or more sections of adhesive 228 may be disposed near the edge(s) of the bib 212 and may substantially conform to at least a portion of an outer shape of the bib 212, as shown in FIG. 3. The adhesive 228 may be used to secure the corresponding portions of the bib 212 to an underlying substrate (not shown), such as an article of clothing worn by the fencer, e.g., a fencing jacket. The adhesive 228 may comprise, for example, a pressure-sensitive adhesive that allows the bib 212 to be repeatedly adhered to, and removed from, the substrate so that the bib 212 may be reusable. With reference to FIGS. 3 and 5, the bib 12, 212 may comprise a triangular bottom edge 14B, 214B, which may help the bib 12, 212 to conform more closely to the fencer's upper body 400 and/or to the fencer's clothing. The bib 212 may optionally include the ties and/or belt(s) (not labeled in FIG. 3; shown with dashed lines to indicate that they are optional), or the ties and/or belt(s) may be eliminated, as the adhesive 228 will couple the bib 212 to the fencer's upper body 400.

In accordance with the present disclosure, at least a portion of the bib comprises a material that is configured to provide an observable change in response to an external stimulus. As used herein, the term “observable change” may refer to a change in at least one property of the bib that is visible to an adult human being with normal vision and color perception who is observing the bib unaided under indoor lighting conditions and/or a change in at least one property of the bib that is perceptible by touch. The observable change may be permanent or semi-permanent, as described herein in more detail.

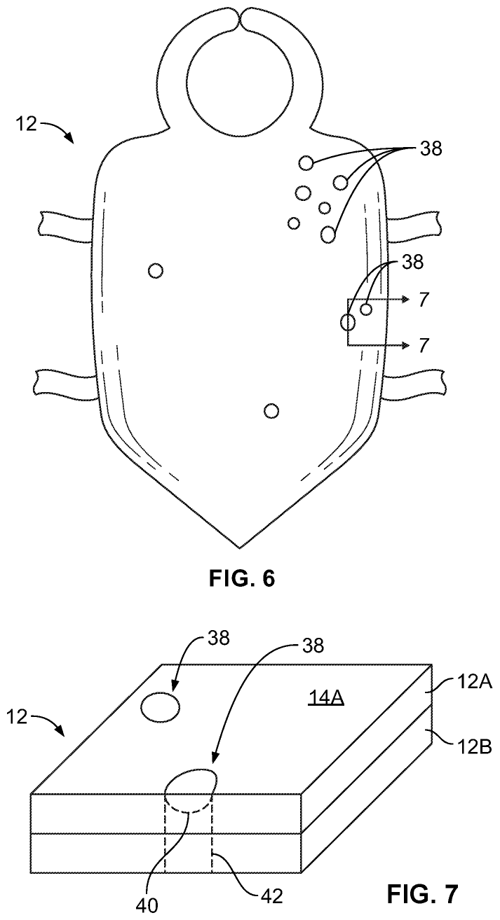

As shown in FIG. 5, during a fencing match or training session, the two fencers typically touch each other multiple times with their fencing weapons 30. The fencers receive a point for each touch or “hit.” As described herein, the bib 12 displays one or more observable changes 38, in which each observable change 38 corresponds to one of the touches of the fencing weapon 30 on the bib 12. FIG. 6 provides a representation of the bib 12 from FIG. 5 following a bout of fencing, in which a plurality of observable changes 38 are depicted. In this manner, the bib 12 provides a record of the hits that the fencer received on the bib 12 and the locations of the hits. The fencer may review the bib 12 during and/or after the match or training session, and based on the observable changes 38, the fencer may assess where hits are occurring and whether the hits are concentrated in any particular area of the bib 12. The fencer may identify areas of vulnerability and may adjust his or her technique to avoid hits in those area(s) in subsequent fencing bouts. For example, as shown in FIG. 6, the fencer sustained multiple hits in the upper left quadrant of the bib 12, which may represent an area that the fencer should monitor more carefully in the future.

As shown in FIG. 7, in some examples, the bib 12 may comprise two or more layers comprising an outer layer 12A and at least one inner layer 12B, in which the portion of the bib 12 with the material that provides the observable change may comprise the outer layer 12A. The portion of the bib 12 with the material that provides the observable change may comprise substantially an entirety of the front face 14-1 of the bib 12 (see also FIGS. 1 and 2).

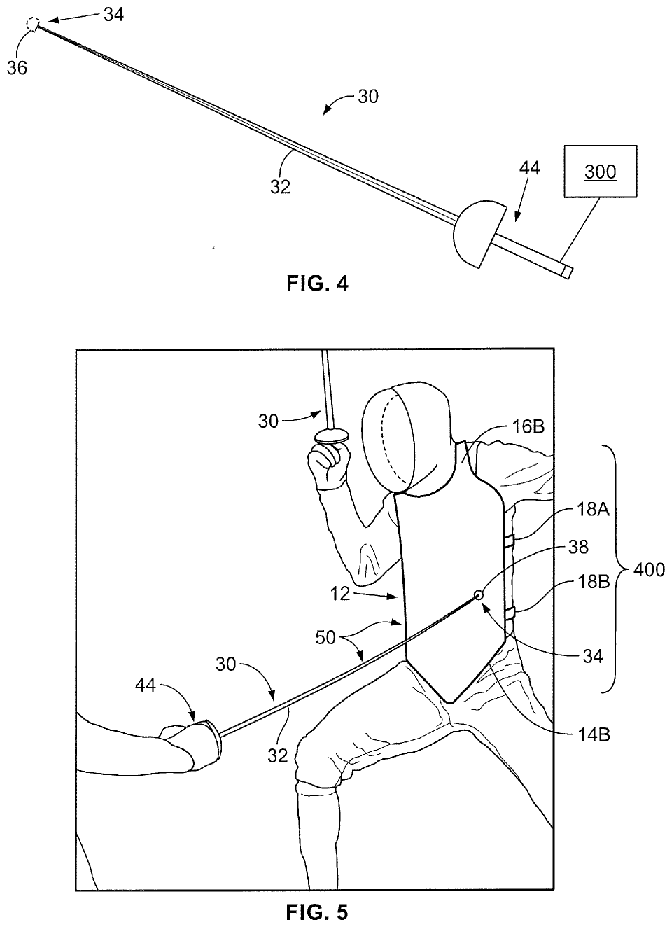

In some examples, the material may comprise a “smart” material such as a chromic material that provides a visible change from a first color to a second color in response to the external stimulus. The first and second colors may comprise colors with high contrast. For example, the first color may preferably be a light color or white, and the second color may preferably be a darker color or black that will be highly visible against portions of the material that are still the first color and/or against other areas of the bib and/or uniform. The chromic material may comprise, for example, an ink, dye, pigment, paint, or other material that may be applied to a surface of, or incorporated into, a substrate such as fabric, paper, or a polymeric matrix. With reference to FIG. 4, the fencing weapon 30 may comprise a handle 44 and a blade 32 with a tip 34, in which the tip 34 or an attachment 36 coupled to the tip 34 provides the external stimulus.

In some instances, the chromic material may comprise a mechanochromic material, and the external stimulus may comprise one or more mechanical forces such as compression, friction, and/or other mechanical stress that result from the tip 34 of the fencing weapon 30 touching the bib 12. The chromic material may comprise a piezochromic material that exhibits a color change induced by application of pressure. For example, with reference to FIG. 5, when the tip 34 of the fencing weapon 30 contacts the bib 12, the tip 34 applies a pressure to the piezochromic material of the bib 12, which causes a small amount of compression and results in a visible color change in the portion of the bib 12 that is contacted by the tip 34. Tribochromic materials are a type of mechanochromic material that similarly exhibit a visible color change in response to mechanical friction, which may occur along with compression when the tip 34 of the fencing weapon 30 touches the bib 12.

In other instances, the chromic material may comprise a photochromic material, and the external stimulus may comprise irradiation. With reference to FIG. 4, the fencing weapon 30 may be coupled to a source 300 (e.g., via dedicated wiring or via existing wiring used with an electronic scoring system) that provides power, and the tip 34 may comprise an attachment 36 configured to use the power from the source 300 to cause the fencing weapon 30 to emit electromagnetic radiation of a predetermined wavelength and frequency. In other examples, the source 300 may also represent a battery so that the setup may be wireless. When the tip 34 of the fencing weapon 30 comprising the attachment 36 contacts the bib 12, as shown in FIG. 5, the photochromic material in the portion of the bib 12 that is contacted absorbs the electromagnetic radiation being emitted by the attachment 36 and visibly changes color.

In further instances, the chromic material may comprise an electrochromic material, and the external stimulus may comprise an applied voltage. For example, with reference to FIG. 4, the source 300 may comprise a power source (wired or wireless), and the attachment 36 on the tip 34 of the fencing weapon 30 may be configured to apply a small (harmless) amount of voltage upon contact of the tip 34 of the fencing weapon 30 with the bib 12, as shown in FIG. 5. The electrochromic material in the portion of the bib 12 that is contacted visibly changes color in response to the application of voltage. Magnetochromic materials are a type of chromic material that similarly exhibit a visible color change in response to exposure to a magnetic field. For example, the attachment 36 on the tip 34 of the fencing weapon 30 may comprise a magnet (e.g., a magnetic material or an electromagnet), and the magnetochromic material in the portion of the bib 12 that is contacted visibly changes in color in response to contact with the magnet.

In yet further instances, the chromic material may comprise a thermochromic material or a cryochromic material, and the external stimulus may comprise a change in temperature. Thermochromic material exhibits a visible color change in response to a temperature increase, while cryochromic materials exhibit a visible color change in response to a temperature decrease. For example, with reference to FIGS. 4 and 5, the source 300 may comprise a power source (wired or wireless), and the attachment 36 on the tip 34 of the fencing weapon 30 may be configured to heat at least a portion of the attachment 36 (e.g., an outer surface) to a temperature sufficient to cause the thermochromic material to change color upon contact of the tip 34 of the fencing weapon 30 with the bib 12. In other examples, the source 300 may comprise a coolant source, and the attachment 36 may be configured to cool at least a portion of the attachment 36 (e.g., the outer surface) to a temperature sufficient to cause the thermochromic material to change color upon contact of the tip 34 of the fencing weapon 30 with the bib 12.

In yet further instances, the chromic material may comprise a hydrochromic material, and the external stimulus may comprise contact with water. With reference to FIGS. 4 and 5, the source 300 may comprise a water source, and the attachment 36 on the tip 34 of the fencing weapon 30 may be configured to supply water to the tip 34 of the fencing weapon 30. When the tip 34 contacts the bib 12, the hydrochromic material visibly changes color in response to contact with the water supplied via the attachment 36.

In other examples, the portion of the bib may comprise a substantially planar and continuous sheet or block of material in which the external stimulus may comprise contact with the tip 34 of the fencing weapon 30 and the observable change may comprise an indentation and/or a puncture that may be visible and/or perceptible by touch. With reference to FIG. 7, in some instances, the portion of the bib 12 may comprise a material that is compressible, and when the tip 34 of the fencing weapon 30 contacts the bib 12, the material deforms to produce an indent 40 extending partially through the bib 12 or a layer 12A thereof. In other instances, the portion of the bib 12 may comprise a material that may be pierced when the tip 34 of the fencing weapon 30 contacts the bib 12 to form a puncture 42 that extends completely through the bib 12 or one or more layers 12A and 12B thereof.

In further examples, the portion of the bib may comprise a material that receives a transferable material, in which the external stimulus may comprise contact with the transferable material and the observable change may comprise the transfer of the transferable material onto the portion of the bib. With reference to FIGS. 4 and 5, the attachment 36 on the tip 34 of the fencing weapon 30 may comprise the transferable material such as an ink, chalk, or wax that is transferred onto the bib 12 when the tip 34 contacts the bib 12.

In some instances, the observable change may be substantially permanent and/or irreversible (i.e., attempts to remove or reverse the observable change damages or destroys the bib), such that the bib is discarded or recycled following use. For example, application of the external stimulus may cause an irreversible change in a chromic material (e.g., by formation or breaking of bonds) that results in a permanent color change. In the case of materials such as paper or certain foams (e.g., Styrofoam) that are indented or punctured upon contact with the tip, the indent or puncture may cause permanent and irreparable damage to the structure of the material. A transferable material such as ink (e.g., from a permanent marker or stamp) may bond or adhere so strongly to the bib upon transfer that the observable change is essentially permanent and irreversible.

In other instances, the observable change may be semi-permanent and/or reversible, such that the bib may be restored substantially to an original state (e.g., an original color and/or structure) and may be reusable. For example, some chromic materials exhibit a time-dependent color change and may revert back to the first (original) color within a predetermined amount of time following removal of the external stimulus. For example, thermochromic and cryochromic materials may revert back to the first color when the material cools or warms, respectively, back to a particular temperature. Hydrochromic materials may revert back to the first color upon evaporation of the water. Other chromic materials may revert back to the first color upon application of a second external stimulus, such as exposure to a particular wavelength and/or frequency of electromagnetic radiation, heating or cooling, or application of a fluid such as water.

Materials that are indented or punctured upon contact with the tip may similarly revert back to an original state (e.g., substantially planar and continuous) with the passage of time and/or application of a second external stimulus For example, shape memory polymers and other elastic materials may return to their original shape over time or with the application of heat or other external stimulus, such that indents caused by the tip substantially disappear. Self-healing materials may repair punctures over time and/or with the application of heat, electromagnetic radiation, water, or other external stimulus.

The material of the bib and/or the transferable material may be selected such that the transferable material is semi-permanent and may be removed from the bib following use. For example, the bib may comprise a material such as a polymer film or a polymer-coated or -infused substrate (e.g., melamine), and the transferable material may comprise a dry- or wet-erase ink, a wax (e.g., a wax pencil), or chalk. The observable changes due to the transfer of the transferable material may remain in place on the bib until the transferable material is removed by, for example, wiping or rubbing the bib with a dry or wet cloth or with a cloth comprising a cleaning solution or degreaser.

With reference to FIG. 5, a system 50 for training a fencer may comprise a bib 12 and a fencing weapon 30 in accordance with the present disclosure. As described herein, at least a portion of the bib 12 comprises a material configured to provide an observable change in response to an external stimulus. Also as described herein, the fencing weapon 30 comprises a handle 44 and a blade 32 with a tip 34 that is configured to provide the external stimulus. With reference to FIG. 4, the system 50 may also comprise the attachment 36 coupled to the tip 34 of the fencing weapon 30 and/or the source 300 coupled to the fencing weapon 30.

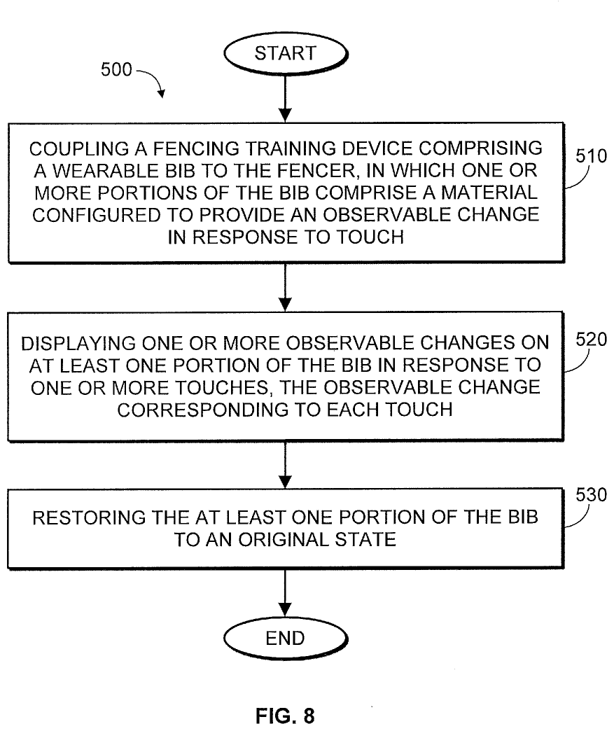

FIG. 8 is a flowchart illustrating a method 500 of training a fencer. The method 500 begins at Step 510 with coupling a fencing training device comprising a wearable bib to the fencer, in which one or more portions of the bib comprise a material configured to provide an observable change in response to touch. At Step 520, one or more observable changes are displayed on at least one portion of the bib in response to one or more touches, in which the observable change corresponds to each touch. The at least one portion of the bib is restored to an original state at Step 530, after which the method may conclude.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” In addition, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fencing training device comprising a bib, wherein at least a portion of the bib comprises a material configured to provide an observable change in response to an external stimulus.

2. The fencing training device of claim 1, wherein the material comprises a chromic material and the observable change comprises a visible change from a first color to a second color.

3. The fencing training device of claim 2, wherein the chromic material comprises a piezochromic material and the external stimulus comprises application of pressure.

4. The fencing training device of claim 2, wherein the chromic material comprises a photochromic material and the external stimulus comprises irradiation.

5. The fencing training device of claim 2, wherein the chromic material comprises one of:
a thermochromic material and the external stimulus comprises a temperature increase; or
a cryochromic material and the external stimulus comprises a temperature decrease.

6. The fencing training device of claim 2, wherein the chromic material comprises an electrochromic material and the external stimulus comprises an applied voltage.

7. The fencing training device of claim 2, wherein the chromic material comprises a hydrochromic material and the external stimulus comprises contact with water.

8. The fencing training device of claim 1, wherein the observable change comprises one of a puncture or an indentation and the external stimulus comprises contact with a tip of a fencing weapon.

9. The fencing training device of claim 1, wherein the observable change comprises a transfer of a transferable material onto the portion of the bib and the external stimulus comprises contact with the transferable material.

10. The fencing training device of claim 1, wherein the portion of the bib comprises an outer layer of the bib.

11. The fencing training device of claim 1, wherein the portion of the bib comprises substantially an entirety of a front face of the bib.

12. The fencing training device of claim 1, wherein the bib is wearable and is configured to be coupled to one or more portions of a fencer's upper body.

13. The fencing training device of claim 12, wherein the bib comprises an adhesive disposed on a rear face.

14. The fencing training device of claim 1, wherein the bib is reusable.

15. A fencing weapon comprising a handle and a blade with a tip, wherein the tip of the fencing weapon comprises a transferable material disposed thereon.

16. The fencing weapon of claim 15, wherein the transferable material comprises ink, chalk, or wax.

17. A system for training a fencer comprising:
a bib according to claim 1; and
a fencing weapon comprising a handle and a blade with a tip, wherein the tip of the fencing weapon is configured to provide the external stimulus.

18. The system of claim 17, wherein the material comprises a chromic material and the observable change comprises a visible change from a first color to a second color.

19. The system of claim 17, wherein the tip comprises a transferable material that produces the observable change and the external stimulus comprises contact with the tip.

20. A method of training a fencer comprising:
coupling a fencing training device comprising a wearable bib to the fencer, wherein one or more portions of the bib comprise a material configured to provide an observable change in response to touch;
displaying one or more observable changes on at least one portion of the bib in response to one or more touches, the observable change corresponding to each touch; and
restoring the at least one portion of the bib to an original state.
